(19) United States
(12) Patent Application Publication
(10) Pub. No.: US 2016/0335909 A1
(43) Pub. Date: Nov. 17, 2016

(54) ENHANCING ENTERPRISE LEARNING OUTCOMES

(71) Applicants: International Business Machines Corporation, Armonk, NY (US); Skillsoft Ireland Limited, Dublin (IE)

(72) Inventors: John J. Ambrose, Nashua, NH (US); Yi-Min Chee, Yorktown Heights, NY (US); Wesley M. Gifford, Ridgefield, CT (US); Ashish Jagmohan, Irvington, NY (US); Laura W. Rexford, Woodstock, GA (US); Suzanne M. Rodeman, Fairport, NY (US); Anshul Sheopuri, Teaneck, NJ (US); Piyawadee Sukaviriya, White Plains, NY (US)

(21) Appl. No.: 14/711,877

(22) Filed: May 14, 2015

(51) Int. Cl. G09B 19/00; G06N 5/02; G09B 5/02

(52) U.S. Cl. CPC G09B 19/00; G09B 5/02; G06N 5/02

(57) ABSTRACT

Enterprise learning system may receive as input learning goals for a learner. Learning goals may also be specified by job-roles. The system may output course-sequence recommendations, sequence-associations to learning goals and learning-goal recommendations. A semantic analysis may automatically relate learning-goals to learning assets and job-roles. Computational semantic relation-finding may leverage available knowledge-bases. A sequence-recommendation recommends course or learning asset sequences to the learner based on historical usage, the learner's current and/or desired job-roles and learning goals.

### FIELD

The present application relates generally to computers and computer applications, and more particularly to an automated computer system for enterprise learning.

### BACKGROUND

Enterprise learning refers to computer system in which users such as employees of an enterprise can gain knowledge or skills Examples may include online courses or classes in the context of an enterprise, information technology (IT) development, negotiation skill, management skills, leadership, and others. A user may log in to the computer system, select courses and via the courses acquire the corresponding skills. While system exist that offer actions for achieving competencies, associations between recommendations and competencies are determined manually.

### BRIEF SUMMARY

A system and method for enhancing learning outcomes may be provided. The system, in one aspect, may comprise an entity annotation module operable to execute on one or more hardware processors, and further operable to automatically extract concepts from learning assets and characterize the learning assets by mapping entities of a knowledge-base to the concepts, to generate learning assets to concepts mapping. A learning goal extraction and alignment module may be operable to execute on the one or more of the hardware processors, and further operable to map learning goals to the learning assets at least based on the learning assets to concepts mapping and asset to competency mapping. A sequence extraction and alignment module may be operable to execute on the one or more of the hardware processors, and further operable to extract sequences of the learning assets from historical consumption data, and recommend one or more of the sequences of the learning assets corresponding to the learning goals.

A method of enhancing learning outcomes, in one aspect, may comprise generating learning assets to concepts mapping, automatically by one or more processors, by extracting concepts from learning assets and characterizing the learning assets by mapping entities of a knowledge-base to the concepts. The method may also comprise receiving one or more of a learning goal. The method may further comprise mapping the learning goal to the learning assets at least based on the learning assets to concepts mapping and asset to competency mapping, the asset to competency mapping comprising mappings of assets to learning goals mapped based on the entities of the knowledge-base. The method may also comprise extracting sequences of the learning assets from historical consumption data. The method may further comprise recommending one or more of the sequences of the learning assets corresponding to the learning goal.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a diagram illustrating components of a system that enhances learning outcomes in one embodiment of the present disclosure.

FIG. 2 is another diagram illustrating system components that enhance learning outcomes in one embodiment of the present disclosure.

FIG. 3 is a diagram illustrating an example of entity annotation used in one embodiment of the present disclosure.

FIG. 4 is a diagram illustrating characterizing of learning goals in one embodiment of the present disclosure.

FIG. 5 is a diagram illustrating a sequence extraction and alignment component in one embodiment of the present disclosure.

FIG. 6 shows a graph plotting example number of frequent sequences mined based on sequence length.

FIG. 7 is a diagram illustrating semantic relational matching in one embodiment of the present disclosure.

FIG. 8 shows an example of entity annotations of assets and learning goals in one embodiment of the present disclosure.

FIG. 9 shows an example of matching assets to learning goals in one embodiment of the present disclosure.

FIG. 10 shows an example knowledge-base graph in one embodiment of the present disclosure.

FIG. 11 shows example asset entities and learning goal entities in one embodiment of the present disclosure.

FIG. 12 shows generative latent-variable model process in one embodiment of the present disclosure.

FIG. 13 is a diagram showing inferring of goal-asset matches in one embodiment of the present disclosure.

FIG. 14 is an example user interface in one embodiment of the present disclosure.

FIG. 15 is a diagram showing an example matching performance of a methodology of the present disclosure in one embodiment.

FIG. 16 is a flow diagram illustrating a method of improving learning outcomes in one embodiment of the present disclosure.

FIG. 17 illustrates a schematic of an example computer or processing system that may implement the learning system in one embodiment of the present disclosure.

### DETAILED DESCRIPTION

In one aspect, a system and/or method in the present disclosure may enhance or improve enterprise learning outcomes. The system and/or method may take as input one or more learning goals for a learner (referred to also as a target user) and/or a job-role. An example of a learning goal may be “learn about Big Data.” Another example of an input may be a job-role. For instance, a learner may be an IT developer who has a goal to become a project manager. The system and/or method of the present disclosure may output one or more course-sequence recommendations (e.g., a sequence of courses that a learner should do), sequence-associations to learning goals, and learning-goal recommendations. The sequence-associations to learning goals for example provide the system's reasons for recommending those course-sequence recommendations, e.g., indicating the level of help the courses would provide in achieving the learning goal or job-role. The sequence-associations may be provided as quantitative measurements, e.g., if the recommended course sequence is completed, the learning is 50% close to achieving the learning goal or job-role. Other examples of measurement values may be low, medium, high. The learning-goal recommendations provide other learning goals related to the input learning goal or job-role. For example, a user can enter in learning goals for a current position or desired job-role of a target user and receive one or more of course-sequence recommendations, sequence associations to learning goals, and learning goal recommendations. An example of a learner or target user is an employee of an enterprise. For instance, an entity's learning officer (as a user) may enter learning goals for an employee of the entity, for example, for the employee's current or desired job-role. The user who enters the learning goals may also be the learner or target user.

A semantic analysis method may automatically relate learning-goals to courses and job-roles. In one aspect, this may be done through computational semantic relation-finding leveraging external knowledge-bases that are available. Examples of external knowledge-base may include, but are not limited to, Dbpedia and Freebase. Briefly, DBpedia database currently provides structured information from Wikipedia, a crowd-sourced data, and is available on the Web. Freebase is a large collaborative knowledge-base, an online collection of structure data composed by community members. The semantic analysis method reasons about the learning goals, courses and job-roles, for example, based on the textual description of learning goals, courses and job-roles, or examples courses associated with the learning goals, and linking them to an knowledge base.

A sequence-recommendation method may recommend course-sequences to the learner based on historical usage (e.g., over a single or multiple enterprises or companies), the learner's current and/or desired job-roles, and learning goals. This method, in one embodiment, determines the sequences of courses that is appropriate for an individual to take for the learning goal or job-role.

A system user interface (UI) may allow a learner to discover new learning goals and to explore recommended course-sequences and their associations with the learner's job-roles and goals.

In one embodiment, all of the above may be done in a completely automated, data-driven manner, based on historical usage and textual descriptions of goals, jobs, courses.

The system and/or method of the present disclosure provide advantages in that the system and/or method may be completely automated, for example, using computational semantic-reasoning and data-mining techniques. The system and/or method may provide holistic reasoning, combining desired learning goals, job-roles and historical usage to generate recommendations. The system and/or method may be scalable in that the system and/or method can automatically extract a large number of new learning goals (e.g., thousands) and associations (e.g., millions).

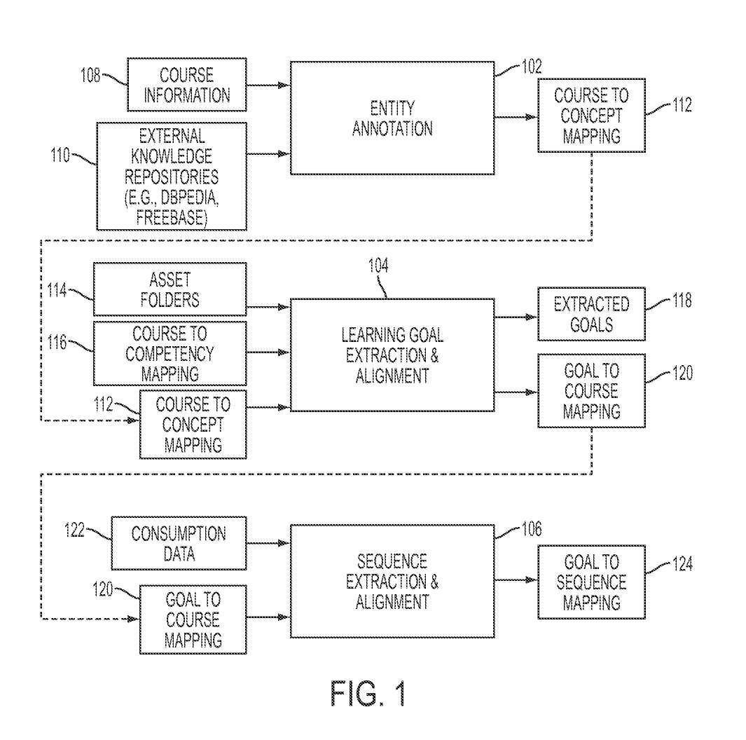

FIG. 1 is a diagram illustrating components of a system that enhances learning outcomes in one embodiment of the present disclosure. In one embodiment, the system and/or methodology of the present disclosure may comprise the following components: (1) entity annotation 102, (2) learning goal extraction and alignment 104, and (3) sequence extraction and alignment 106. The components may be implemented as computer executables that execute on one or more hardware processors. The entity annotation component 102 may automatically extract, resolve and disambiguate concepts from course descriptions and objectives using external knowledge-bases (e.g., DBpedia), and link courses to those extracted concepts. For example, the textual description associated with course information may be translated to entities described in a knowledge-base.

The learning goal extraction and alignment component 104 may expand curated competency—course mapping(s) by extracting a broader set of learning goals from all content and mapping goals to individual courses. For example, textual description of learning goals or examples of courses associated with learning goals may be mapped to knowledge-base entities to generate learning goal entities for each of a plurality of learning goals. This component 104, in one embodiment, aligns the learning goal entities with course to concept mapping (referred to as asset entities), generating goal to course mapping.

The sequence extraction and alignment component 106 may extract statistically significant course sequences from aggregate consumption data, for example, historical usage data about the courses, and infer sequence associations to learning goals. For instance, this component 106 may identify sequences of courses that have been consumed from historical data, and align one or more sequences with the learning goal.

For instance, the entity annotation component 102 may take as input course information 108 and external knowledge repositories 110, and output a course to concept mapping 112. The learning goal extraction and alignment component 104 may take as input asset folders 114, course to competency mapping 116 and course to concept mapping 112, and output extracted goals 118 and goal to course mapping 120. The sequence extraction and alignment component 106 may take as input consumption data 122 and goal to course mapping 120 and output goal to sequence mapping 124.

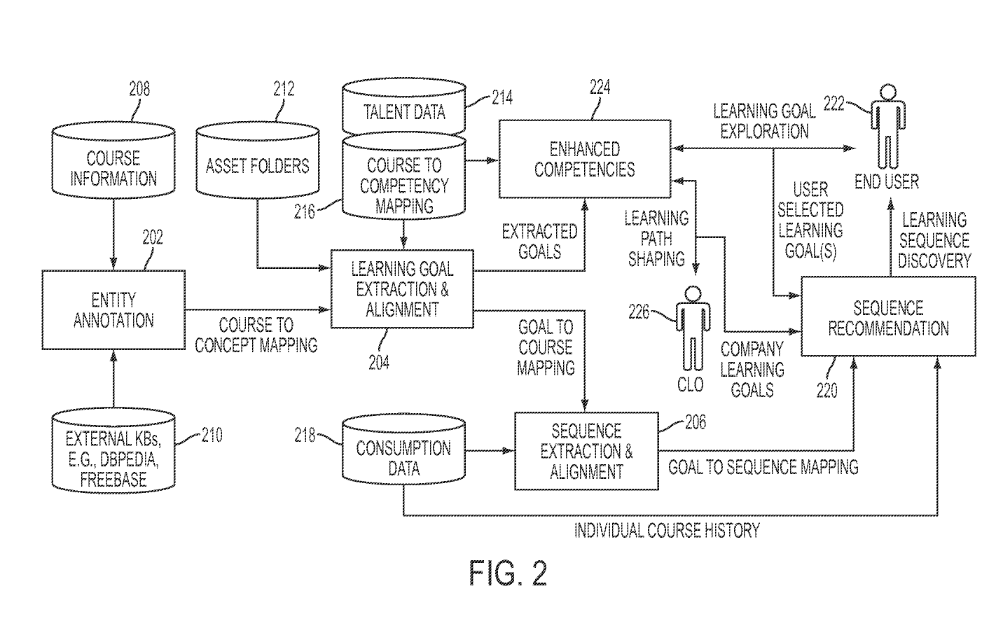

FIG. 2 is another diagram illustrating system components that enhance learning outcomes in one embodiment of the present disclosure. An entity annotation component 202 may receive or retrieve information about available courses from a course information database 208. The entity annotation component 202 may also receive or retrieve learning information from external knowledge-bases. External knowledge-bases may include crowd-sourced structured information made available on the World Wide Web, or other knowledge-bases generated or used outside of the enterprise. Based on the received or retrieved information, the entity annotation component 202 may generate a course to concept mapping. For example, the course to concept mapping relates a particular course or course material to a particular concept, for instance, respectively for all identifiable concepts or courses.

A learning goal extraction and alignment component 204 receives the course to concept mapping generated by the entity annotation component 202. Based on the course to concept mapping and other information such as asset folders 212, talent data 214 and course to competency mapping 216, e.g., stored in respective storage devices or databases, the learning goal extraction and alignment component 204 generates an extended set of learning goals. The extended set of learning goals includes additional goals that are related to the input learning goal. The extended set of learning goals may be stored as enhanced competencies 224, for example, desirable for the learner to acquire, and may be provided to an end user 222. The enhanced competencies 224 may be used by an end user 222 to explore learning goals, and e.g., use as an input learning goal for discovering a recommended sequence of courses to achieve or acquire the learning goal. The enhanced competencies 224 may be also used by an officer of an enterprise to shape or determine learning path for the enterprises employees. The learning goal extraction and alignment component 204 also generates a goal to course mapping. The goal to course mapping comprises the courses related to the input learning goal.

A sequence extraction and alignment component 206 receives the goal to course mapping. Based on consumption data of one or more users, e.g., retrieved from a consumption data database 218, e.g., stored in a storage device, and the goal to course mapping, the sequence extraction and alignment component 206 generates a goal to sequence mapping. The consumption data database 218 stores individual's course history, for example, for a plurality of individuals or learners, for example, a history of which individual consumed which course or course material. The goal to sequence mapping is provided as a sequence recommendation 220 to an end user 222.

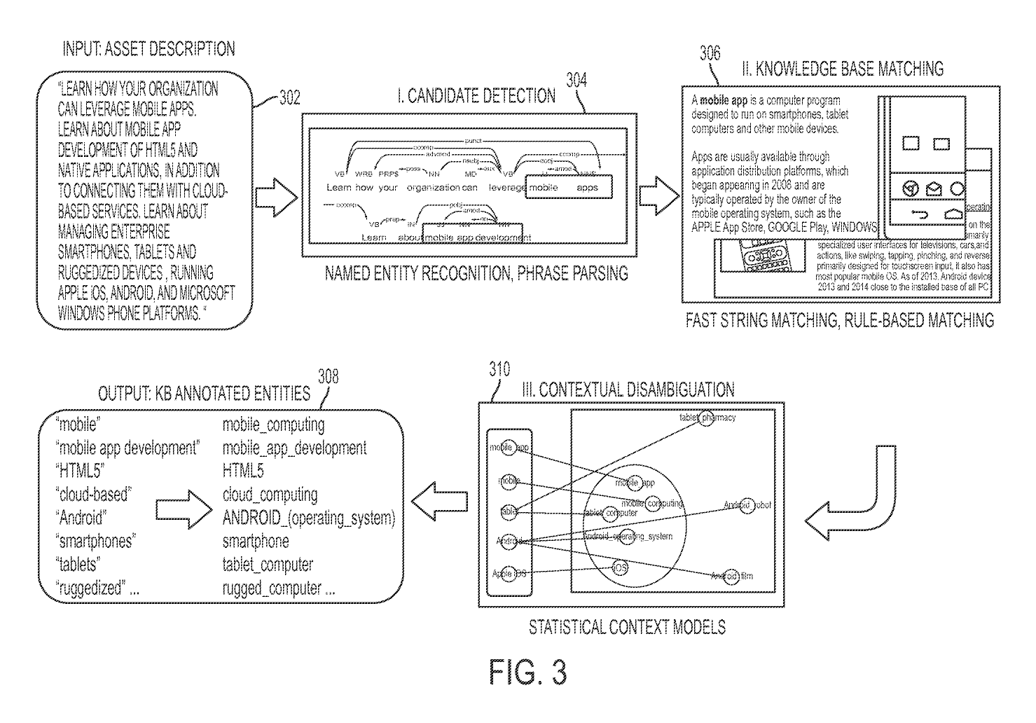

FIG. 3 is a diagram illustrating an example of entity annotation used in one embodiment of the present disclosure. An entity annotation component (e.g., 102 in FIGS. 1 and 202 in FIG. 2) receives as input course information, for example, asset description. An example of an asset description is shown at 302. An asset refers to a piece of learning content, e.g., course material, video, books, other online content, and others. Candidate detection at 304 parses the asset description and recognizes named entities in the asset description. Knowledge-based matching at 306 matches the named entities with concepts in a knowledge-base. For example, fast string matching or rule-based matching that utilizes acronyms and ordering may be performed against a knowledge-base such as Dbpedia. Contextual disambiguation at 308 uses statistical context models to disambiguate matching phrases or words. Output 310 of the entity annotation component includes mapping of course (asset) based on matching words and/or phrases in the asset description 302 with the concepts of a knowledge-base. Knowledge-base concept may be represented as a web page or node, e.g., a Wikipedia page.

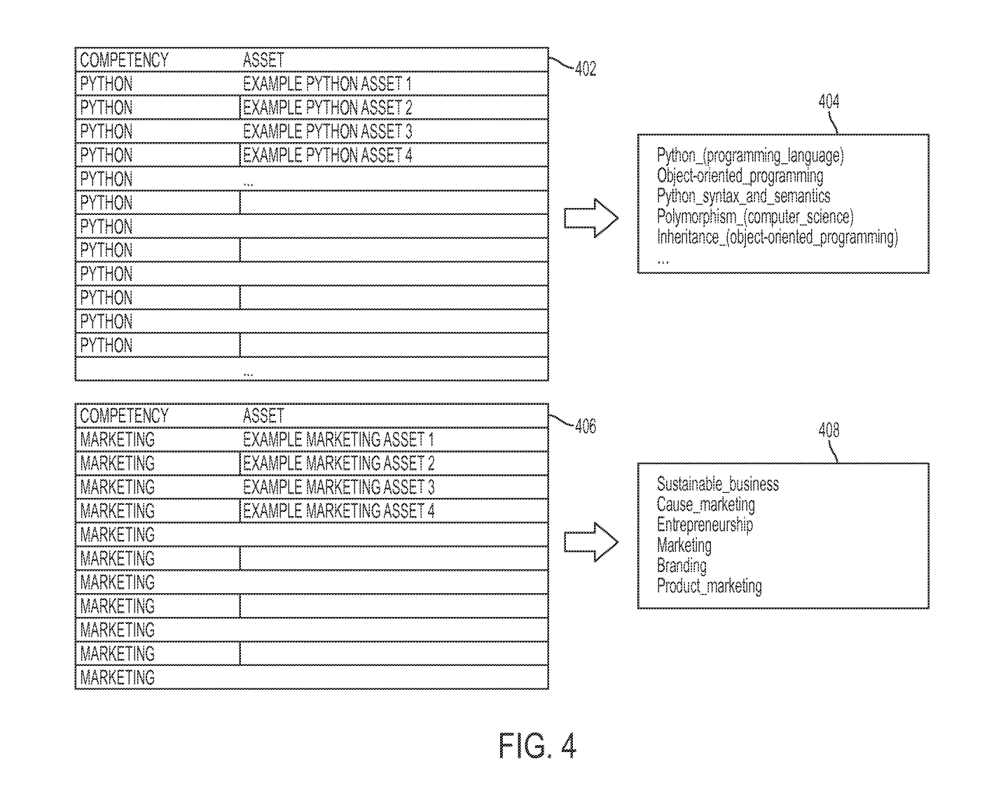

FIG. 4 is a diagram illustrating characterizing of learning goals in one embodiment of the present disclosure. For instance, the entity annotation component (e.g., 102 in FIGS. 1 and 202 in FIG. 2) may characterize learning goals. For example, example assets 402 relating to competency topic (e.g., Python) may be characterized according to the mapped concepts or entities 404 of knowledge-based. Extracted entities or concepts span range of Python topics: language features, web services, object oriented programming (OOP), apps, and others. Another example assets are shown at 406 that relate to competency topic (e.g., Marketing Essentials) may be characterized according to the mapped concepts or entities 408 of knowledge-base. Extracted entities 408 span range of marketing topics.

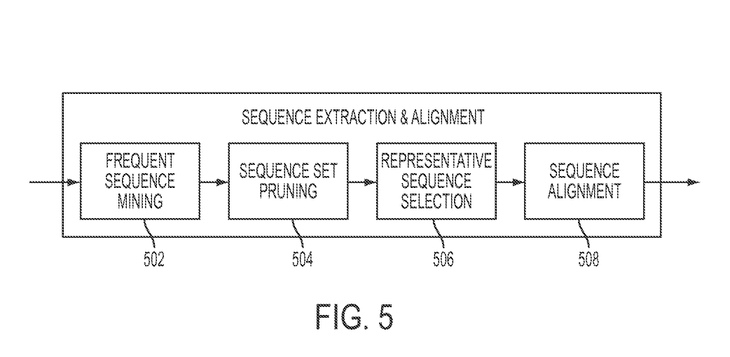

FIG. 5 is a diagram illustrating a sequence extraction and alignment component in one embodiment of the present disclosure. Frequent content consumption patterns are indicative of the order in which content is typically consumed. Proper content ordering presents learning goals appropriately. Once sequences are mapped to learning goals showing user progress along sequence helps motivate the user. A sequence extraction and alignment component (e.g., 106 in FIGS. 1 and 206 in FIG. 2) in one embodiment may perform frequent sequence mining at 502. Frequent sequence mining generates candidate set of sequences by mining sequences with sufficient support. Support refers to the number of occurrences of a particular pattern in the user consumption data. At 504, the set of frequent sequences are pruned to remove undesirable sequences. At 506, representative set sequences are identified that possess the desired length properties and give the desired coverage. At 508, sequence alignment matches user desired learning goals and previously consumed content to available sequences.

Sequence mining can be challenging. Consider two different users' consumption patterns which contain assets from multiple areas of interest: A) Enhancing Listening Skills, Python 101, Python 102; B) Understanding Writing Mechanics Python 101, Negotiation, Python 102, Psychology of Persuasion. The goal is to examine many such consumption patterns and determine the frequent sequences: (Python): Python 101, Python 102; (Negotiation): Negotiation, Psychology of Persuasion. Pattern A contained unrelated courses that were not included in the Python frequent sequence. Pattern B contained elements that made up the two frequent sequences, but these courses were intermingled.

Frequent sequence mining at 502 determines sequences which occur frequently among user interaction sequences. An example of an algorithm that performs frequent sequence mining is shown in Table 1.

TABLE 1
Find frequent 1-sequences

```
Set n=1
Do until no additional frequent items:
  For each n-sequence:
    Find user sequences containing that n-sequence
    Among those sequences find frequent items and
      Form frequent (n+1)-sequences
  Set n=n+1
```

As an example, consider the following learner activity:

### Learner 1: C, B, A, B

### Learner 2: A, B, C, B

### Learner 3: B, C, E, B

### Learner 4: A, C, B, D, E

In the above example, the following sequences have support that is greater than or equal to 3:

Sequence A has support of 3 (supported by activities of Learners 1, 2 and 3);
Sequence A, B has support of 3 (supported by activities of Learners 1, 2 and 3);
Sequence C has support of 4 (supported by activities of Learners 1, 2, 3 and 4);
Sequence C, B has support of 4 (supported by activities of Learners 1, 2, 3 and 4);
Sequence B has support of 4 (supported by activities of Learners 1, 2, 3 and 4);
Sequence B, B has support of 3 (supported by activities of Learners 1, 2 and 3).

In the above example, A, B means a sequence in which B follows A, potentially with other assets in between. See the activity sequences o Learners 1, 2 and 4. The sequence B, B was contained in the activity of Learners 1, 2 and 3. Note that in each case there were different assets between the two visits to B. B, E, B sequence was not a frequent sequence. If it was, it would mean that sequences B, E and E, B occur with at least the same support in the data as B, E, B.

Sequence selection in one embodiment may utilize a modified mining algorithm to mine sequences up to a maximum length. For instance, for support threshold 8 and maximum length 8, in an example dataset, even with those threshold parameters, 78 M (million) sequences can be found. Table 2 illustrates example number of assets for different number of sequence length in mined sequences.

TABLE 2

| | Assets | Coverage (% of |
|---|---|---|
| Length | covered | consumed assets) |
| 1 | 8048 | 20% |
| 2 | 3226 | 8% |
| 3 | 1867 | 5% |
| 4 | 1305 | 3% |
| 5 | 1208 | 3% |
| 6 | 849 | 2% |
| 7 | 734 | 2% |
| 8 | 660 | 2% |

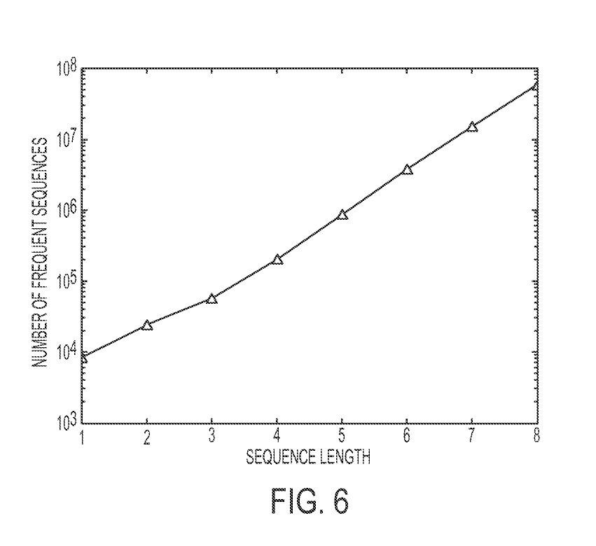

In Table 2, rows with Length 4 to 7 may be considered the lengths of interest. FIG. 6 shows a graph plotting example number of frequent sequences mined based on sequence length. With so many sequences, finding the best among them becomes an important factor.

Referring to FIG. 5, pruning at 504, in one embodiment, may include pruning adjacent and/or non-adjacent duplicate assets. For instance, recommended sequences should not contain adjacent duplicate assets. Pruning adjacent duplicates removes adjacent duplicates from each mined sequences. Table 3 shows an example of a sequence containing adjacent duplicate assets that is pruned. The left side of the arrow is an example of mined sequence. The right side of the arrow is the result of the pruned sequence.

TABLE 3

| | | |
|---|---|---|
| C, B, B, A | -> | C, B, A |
| Mined sequence | | Pruned sequence |

For pruning non-adjacent duplicates, pruning at 504 identifies recommended sequences that contain repeated assets, for instance, because recommended sequences should not contain repeated assets. Pruning non-adjacent duplicates in one embodiment may form an alternative by omitting the duplicate assets. The resulting sequences and their support are recorded. Table 4 shows an example of pruned sequence that removes non-adjacent duplicates. The right sides of the arrows show two alternatives.

TABLE 4

| | | |
|---|---|---|
| C, B, A, B | -> | C, B, A (10) |
| | -> | C, A, B (12) |
| Mined sequence | | Alternatives |

In both examples shown in Table 3 and Table 4, support on the right side is at least equal to support on left.

Table 5 shows example results of mined sequences that are pruned. The system and/or method of the present disclosure may recursively mine all frequent sequences, and hence any sequence with a duplicate may have its non-duplicate versions mined automatically. Pruning can be done automatically while mining, saving time and storage. Drop sequences which are detected contain a duplicate asset. In one aspect, these pruning operations do not reduce the asset coverage.

TABLE 5

| | | Pruned | |
|---|---|---|---|
| Length | Original | (% reduction) | |
| 1 | 8k | 8k | (0%) |
| 2 | 25K | 23k | (8%) |
| 3 | 58K | 47k | (19%) |
| 4 | 211K | 161k | (24%) |
| 5 | 900K | 564k | (37%) |
| 6 | 3.8M | 1.7M | (55%) |
| 7 | 15.3M | 4.1M | (73%) |

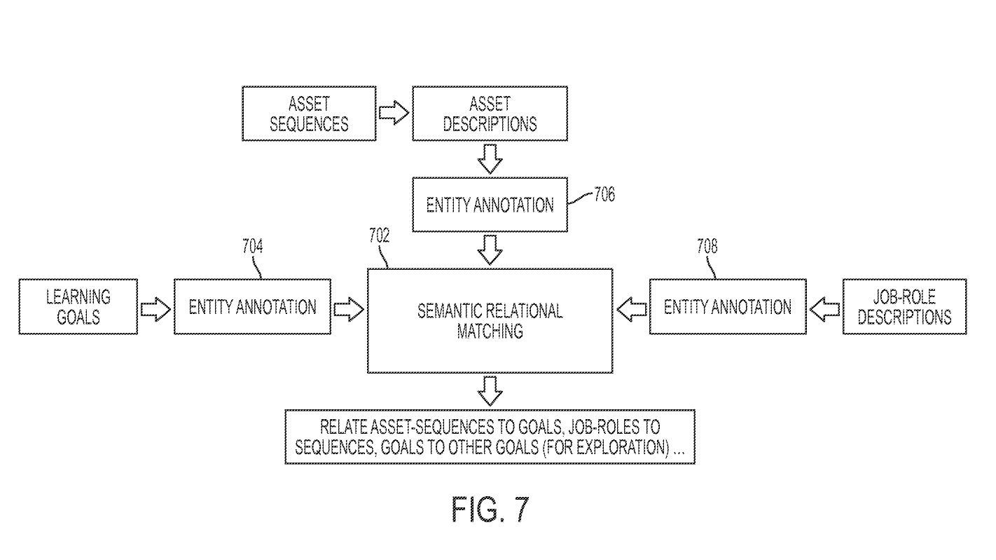

FIG. 7 is a diagram illustrating semantic relational matching in one embodiment of the present disclosure. A semantic relational matching 702 in one embodiment relates or aligns asset-sequences to goals, job-roles to sequences, goals to other goals (e.g., for exploration). For example, the semantic relational matching 702 in one embodiment determines job-roles that are well matched to learning goals and sequences of assets that are well matched to job-roles. The semantic relational matching 702 may be implemented as a computer executable component or method or process. In one embodiment, semantic content matching is built upon knowledge base relations and entities extracted during annotation. The semantic relational matching component 702 (or method) may take as input one or more learning goals that are mapped to entity annotation 704, asset sequences that are mapped to entity annotation 706, and job-role descriptions that are mapped to entity annotation 708.

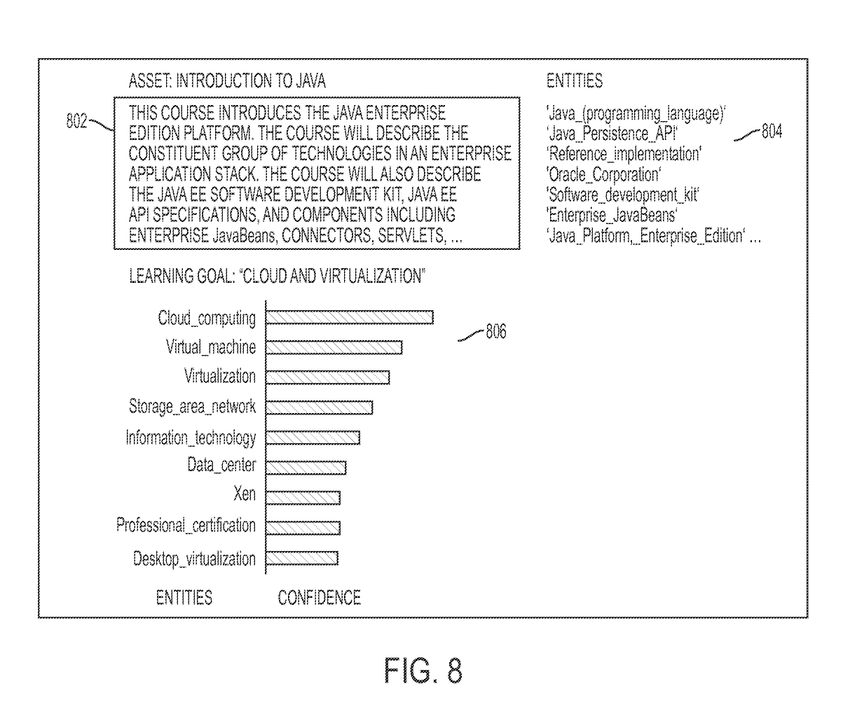

Semantic relational matching is illustrated with the following example that matches assets to learning goals. Input to the semantic relational matching in this example includes entity annotation of assets, e.g., entities (e.g., concepts found in knowledge-base) extracted, using entity annotation, from textual descriptions of assets. Another input includes entity annotation of learning goals, e.g., entities extracted from descriptions of learning goals or from example assets. FIG. 8 shows an example of entity annotations of assets and learning goals in one embodiment of the present disclosure. An example of asset description is shown at 802. This example asset may be a course material on introduction to a particular programming language. The mapped entities are shown at 804. The entities 804 show that the asset 802 is about (or associated with) the shown concepts. Similarly, learning goals may be extracted into entities, e.g., based on the textual description of learning goals from which entities may be extracted, or from examples of assets (e.g., courses) related to learning goals from whose description (e.g., description of example courses) entities may be extracted. Examples of entities that are extracted for the example learning goal related to cloud and virtualization are shown at 806. Confidence value may be determined which indicates how strongly the entities are related to the learning goal. For example, each learning goal may be characterized by (entity, confidence) pairs. In one embodiment, confidence is determined, for example, by the frequency of (number of) the entity occurrence in the learning goal description or in the description of the example assets related to the learning goal.

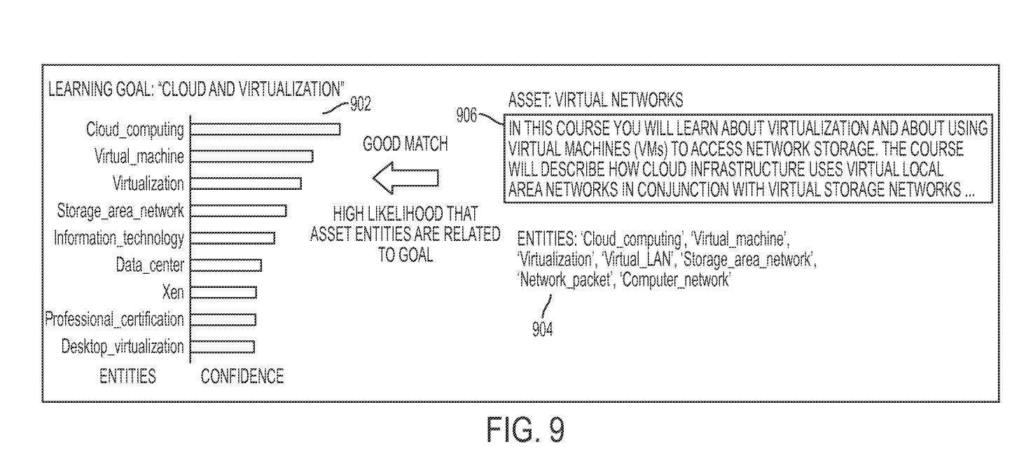

Given the entities associated with each asset of a plurality of assets and entities related to each learning goal of a plurality of learning goals, the semantic relational matching determines whether an asset is related to a learning goal through these entities. An example method for determining whether an asset is related to a learning goal uses a Naïve Bayes Model. This model determines the probability that the entities associated with an asset are related to the entities associated with a learning goal, for instance, that the asset entities are examples of learning goal entities. For example, asset entities that are also learning goal entities, e.g., with a threshold confidence level may be identified as matching. FIG. 9 shows an example of matching assets to learning goals, for example, using the Naïve Bayes Model. Learning goal entities with confidence values are shown at 902. Asset entities 904 extracted from asset description 906 are shown. The asset entities at 904 match the top four highest confidence level learning goal entities at 902.

In one aspect, entity-confidence may be modeled for each goal using multinomial-Dirichlet distribution:

$$P ( entity \vert goal ) = \frac{entity\_freq + α}{{\sum }_{all entities} ( entity\_freq + α )}$$

Naïve-Bayes is a generative probabilistic model. Each asset entity is assumed to be “generated” from the entity distribution of a corresponding goal. Likelihood of asset with entities {eₖ} being generated by learning goal g is:

$$P ( asset \vert g ) = P ( \{ {e}_{k} \} \vert g ) ∝ {\prod }_{e ∈ \{ {e}_{k} \}} P ( e \vert g )$$

For instance, take every entity related with an asset, the likelihood may be determined as the product of the probability of the entities occurring in the learning goal.

The higher the likelihood, the more likely that goal g is a good match for asset. Naïve Bayes Model, in one aspect, may use common entities to infer matching.

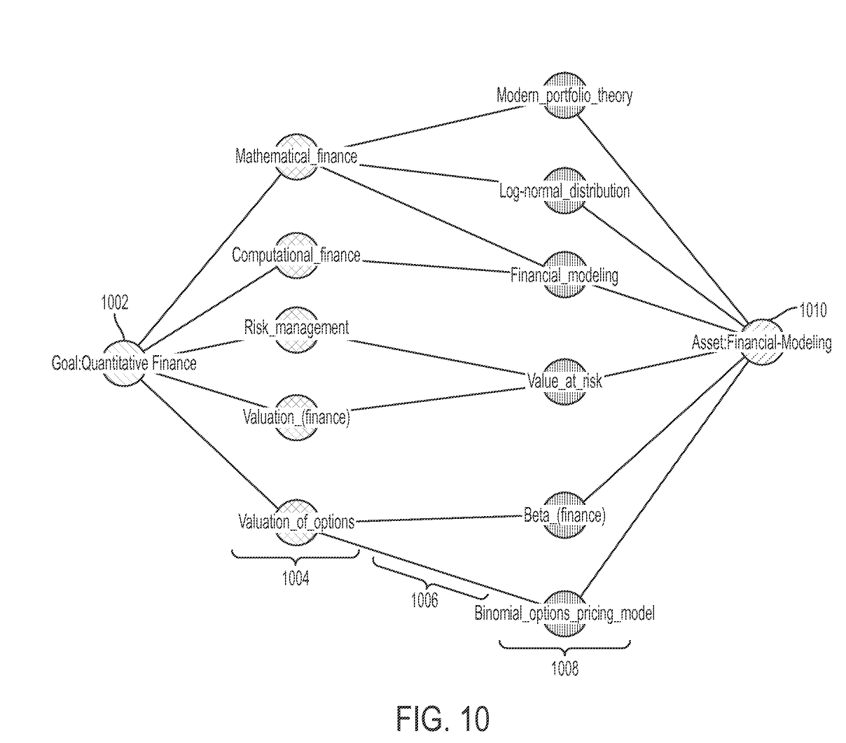

Another example of relational matching leverages knowledge-base relations. This methodology utilizes the entity-linkages contained in the knowledge-base. For instance, examining entity-linkages in a knowledge-base graph reveals the relatedness of asset and learning-goal entities. A semantic knowledge-base graph for instance structures concepts (e.g., web pages of concepts) as nodes of a graph, where related concepts are linked by edges between the nodes. For instance, an online knowledge-base may link pages (e.g., web pages) of related concepts by hyperlinks, e.g., by uniform resource locators (URLs) or a knowledge-base may include a concept page that mentions another concept. The knowledge-base, for example, has entities and the connections between the entities exist, e.g., if an entity mentions or links to another entity, or for example, if a page rank score of a mentioned or linked page is higher than a threshold. Other methods may be used to determine whether an entity (page or node) of a knowledge-base is related to another entity (page or node) of the knowledge-base. FIG. 10 shows an example knowledge-base graph. The entities Modern_portfolio_theory, log-normal_distribution, and Financial_modeling are all directly connected to Mathematical_finance in the knowledge-base graph. Binomial_options_pricing_model and Beta_(finance) are directly connected to Valuation_of_options. Taking entity-linkages into account enhances robust semantic matching. Thus, the entities (1004) associated with a learning goal (1002) can be related to the entities (1008) associated with an asset (1010) via the links identified in a knowledge-base (1006) even if there is no exact textual overlap between the learning goal entities (1004) and the asset entities (1010).

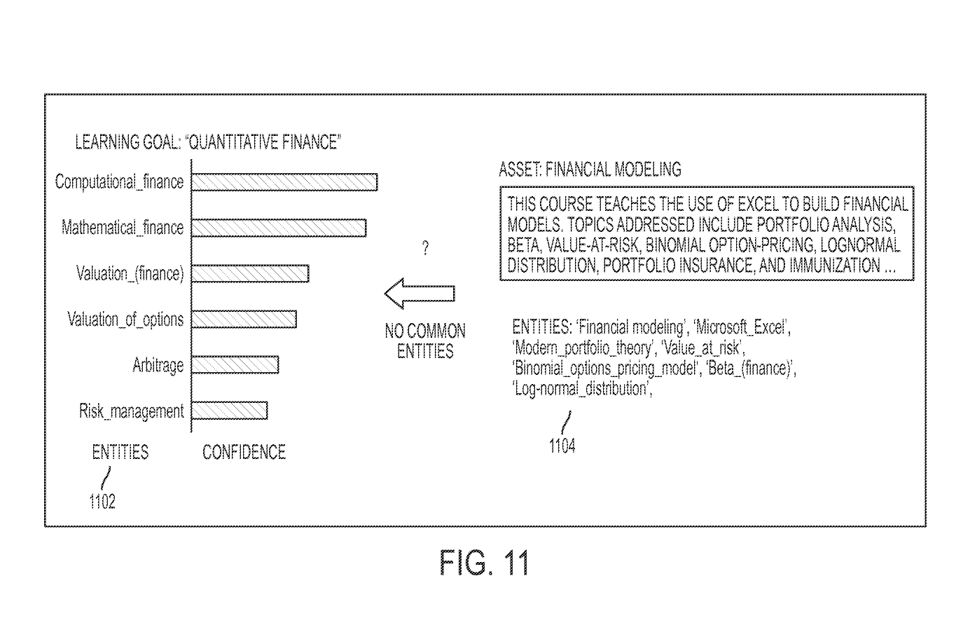

For example, consider the example asset entities and learning goal entities shown in FIG. 11. In this example, there are no common entities between the asset entities 1104 and learning goal entities 1102. In this scenario, related URLs or linked nodes of the assets and learning goals (e.g., FIG. 10) may be utilized to infer relationship between a learning goal and an asset.

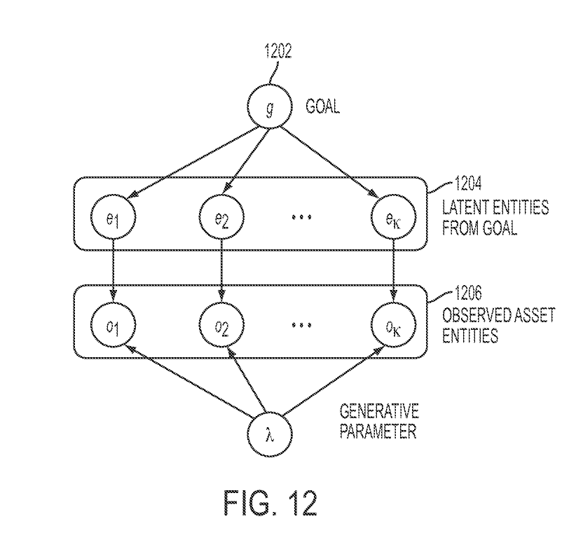

Relation matching may utilize a generative latent-variable model. The latent-variable model captures key intuition such as: Asset may be good match for goal even if asset entities are not identical to the goal entities, but strongly related to them. In the generative probabilistic model, for related asset-goal, asset entities are “generated” from goal entities. FIG. 12 shows generative latent-variable model process in one embodiment of the present disclosure. The generative model may include the following two-step generative process in one embodiment: (1) Entities are probabilistically sampled from the goal-entity distribution, for example, as in Naïve Bayes as shown at 1204. However these entities are latent (hidden). (2) Observed asset entities are generated from the latent goal-entities through the “knowledge-base” distribution as shown at 1206. In one aspect, the closer the knowledge-base distance, the higher the probability that hidden entity morphs into observed entity. For instance, a good asset-entity match is determined when there is a high likelihood (threshold likelihood) of the asset entities being generated from the goal entities.

Knowledge-base distribution may be described as P(oᵢ|eᵢ) ∝exp(−λ·d_{KB} (oᵢ, eᵢ)) where d_{KB}(o, e)=knowledge-base graph distance of o (observed entity), e (entity).

Referring to FIG. 12, given the learning goal with associated entities (bag of entities) at 1202, entities may be randomly from the goal. These are hidden entities. For instance, from a bag of entities associated with a learning goal, a number of learning goals are randomly selected. Each of the entities randomly selected from the bag of entities may be kept or replaced with another entity that is found to be related to the selected entity in the knowledge-base. Selecting a replacement entity from the knowledge-base may be based on the distance between the original selected entity and the candidate replacement entity. The distance may be determined as the number of entities (nodes) in the connection path between the two entities. The set of entities (selected and/or replaced) represents latent entities from goal shown at 1204. The probability that observed asset entities 1206 will have been generated by this random selection process may be computed. The higher the probability, the better the learning goal and the asset are matched to one another.

The following computations may be used to inferring goal-asset matches in one embodiment.

Inferring strength (likelihood) of asset-goal match may be computed as:

$$P ( asset \vert g , λ ) = P ( {\{ {o}_{k} \}}_{k = 1}^{K} \vert g , λ ) ∝ {\prod }_{k = 1}^{K} {\sum }_{e ∈ entities ( g )} P ( {o}_{k} \vert e , λ ) \cdot P ( e \vert g ) {\sum }_{e ∈ entities ( g )} exp ( - λ {d}_{KB} ( {o}_{k} , e ) ) \cdot ( {P}_{emp}^{g} ( e ) + α )$$

Estimating optimized generative parameters may maximize likelihood over all known asset-goal matches as follows:

$${λ}^{*} = argmax {\prod }_{i = 1}^{A} P ( λ \vert \{ {o}_{k}^{i} \} , {g}^{i} ) = argmax {\prod }_{i = 1}^{A} P ( \{ {o}_{k}^{i} \} \vert {g}^{i} , λ ) \cdot exp ( - {λα}_{λ} )$$

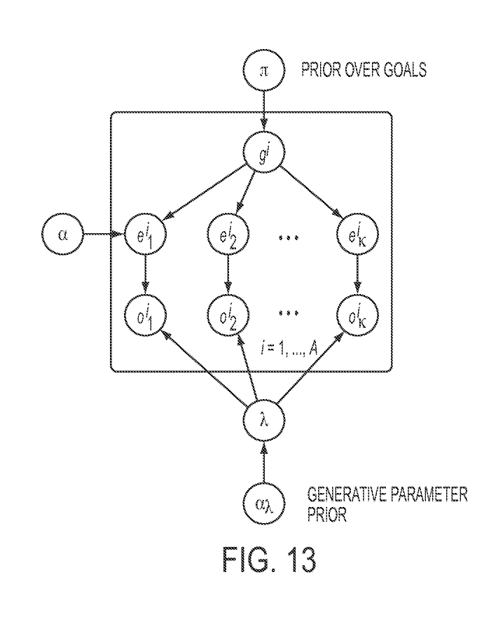

The general model is extensible to inferring, for example, sequence-goal matches, job-sequence matching, and goal-goal matching (for exploration). This model determines whether a goal and an asset are related and how well they may be matched. FIG. 13 is a diagram showing this inferring of goal-asset matches in one embodiment of the present disclosure.

In the above equations, α, λ, α_{λ} are positive real-valued model parameters. In one embodiment, the above equation (paragraph 70) shows how lambda's value (λ) can be set. The values of α and α₂ can be set by a standard model fitting technique, e.g., known in the art including cross-validation, empirical Bayes, regularized risk minimization.

The same methodology described above may be used to infer other matching, e.g., asset-sequences to learning goals, job-roles to asset-sequences, learning goals to other learning goals.

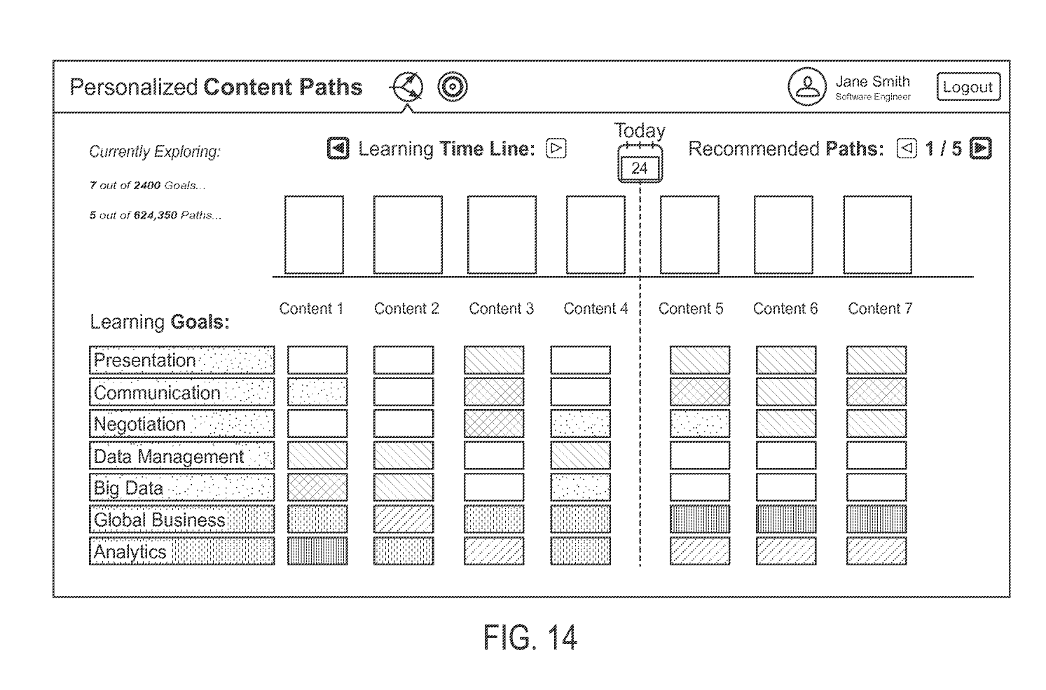

FIG. 14 is an example user interface in one embodiment of the present disclosure. In this screen shot example of a user interface, a user has previously taken the content to the left of the vertical bar labeled “Today”. Based on that consumption and the learning goals that the user has set (“Presentation”, “Communication”, “Negotiation”, “Data Management”, “Big Data”, “Gobal Business” and “Analytics”), the system of the present disclosure in one embodiment recommends the sequence of three assets shown to the right of “Today” (e.g., labeled Content5, Content6, Content7). In this example, the sequence is very closely aligned to “Global Business”, and somewhat less aligned to “Presentation”, “Communication”, and “Negotiation”, for example, as indicated by the matching shadings of the cells (rectangles) corresponding to the content and learning goals.

The performance of the matching engine (or system and/or method) of the present disclosure may be evaluated by using asset-goal pairs which are known to be good matches. In one aspect, known subject matter expert (SME)-generated asset-groups may be used as examples on which to measure matching performance. A performance testing methodology may include using human-generated asset-groups (e.g., asset-folder groupings) as test-groups. Each test-group may be characterized using entity annotation. A set of random assets may be selected from each test-group. For each selected asset, entity-annotation may be performed on asset description. The testing method may use semantic-matching to rank test-groups by strength of relationship between asset and each test-group. Matching accuracy may be measure by determining, e.g., how often the true group is ranked 1? How often in the top 2, 3, 5, . . . ?

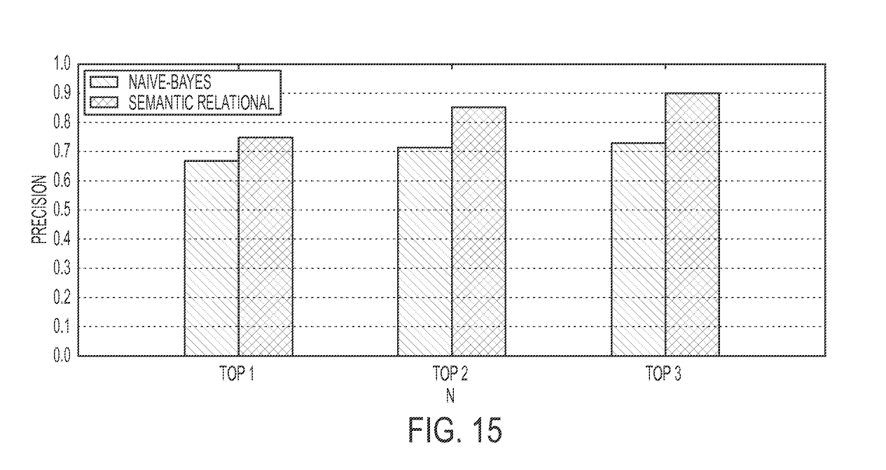

FIG. 15 is a diagram showing an example matching performance which compares Naïve-Bayes and Relational method in one embodiment of the present disclosure. The setting for this experiment utilizes 10 folders covering >4500 assets, characterizes each folder using 10 entities, and takes 100 random assets per folder. Semantic relational matching is run to match folders. Results in this example experiment show that relational matching outperforms Naïve-Bayes significantly. The results show improvement from 70% to 85% (miss-rate reduced by 2×) and from 73% to 90% (miss-rate reduced by 2.7×).

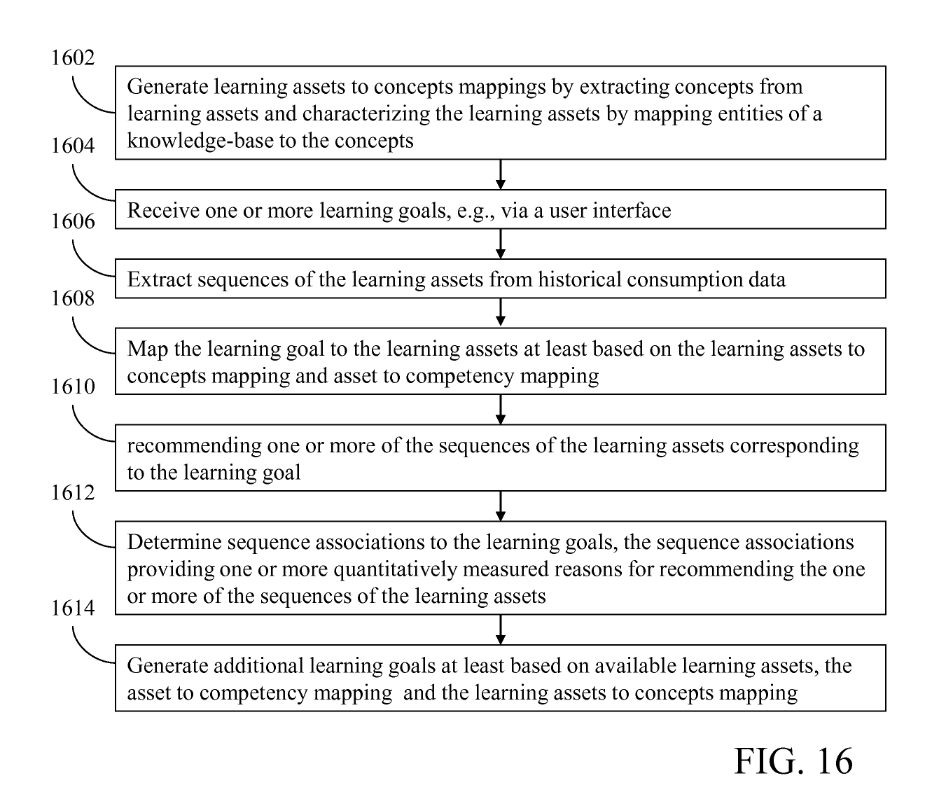

FIG. 16 is a flow diagram illustrating a method of improving learning outcomes in one embodiment of the present disclosure. At 1602, learning assets to concepts mapping may be generated automatically by one or more processors, by extracting concepts from learning assets and characterizing the learning assets by mapping entities of a knowledge-base to the concepts. At 1604, one or more learning goals may be received, for example, via a user interface. At 1606, the method may include mapping the learning goal to the learning assets at least based on the learning assets to concepts mapping and asset to competency mapping, the asset to competency mapping comprising mappings of assets to learning goals mapped based on the entities of the knowledge-base. At 1608, the method may include extracting sequences of the learning assets from historical consumption data. At 1610, the method may include recommending one or more of the sequences of the learning assets corresponding to the learning goal. At 1612, the method may include determining sequence associations to the learning goals. As described above, the sequence associations providing one or more quantitatively measured reasons for recommending the one or more of the sequences of the learning assets. At 1614, the method may include generating additional learning goals at least based on available learning assets, the asset to competency mapping and the learning assets to concepts mapping.

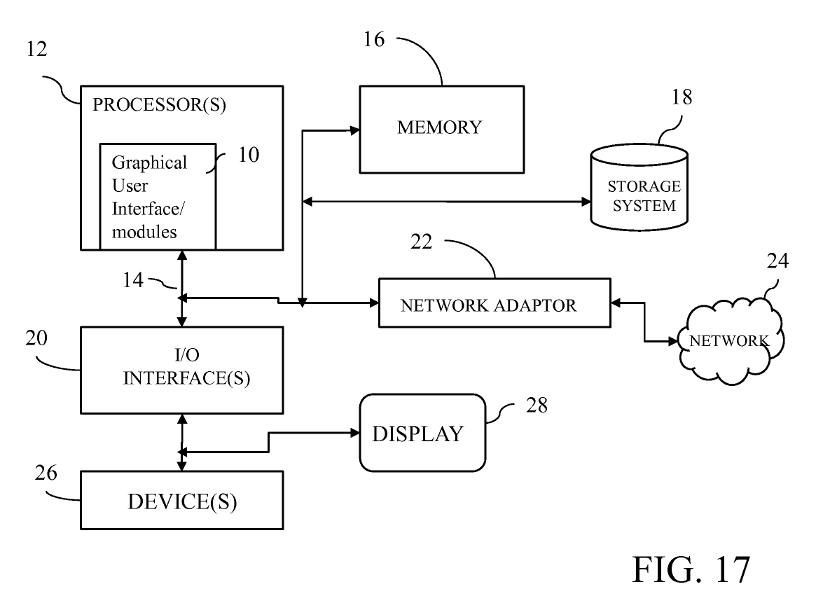

FIG. 17 illustrates a schematic of an example computer or processing system that may implement the learning system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 17 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

We claim:

1. A system for enhancing learning outcomes, comprising:
one or more hardware processors;
an entity annotation module operable to execute on the one or more of the hardware processors, and further operable to automatically extract concepts from learning assets and characterize the learning assets by mapping entities of a knowledge-base to the concepts, to generate learning assets to concepts mapping;
a learning goal extraction and alignment module operable to execute on the one or more of the hardware processors, and further operable to map learning goals to the learning assets at least based on the learning assets to concepts mapping and asset to competency mapping; and
a sequence extraction and alignment module operable to execute on the one or more of the hardware processors, and further operable to extract sequences of the learning assets from historical consumption data, and recommend one or more of the sequences of the learning assets corresponding to the learning goals.

2. The system of claim 1, wherein the sequence extraction and alignment module is further operable to determine sequence associations to the learning goals, the sequence associations providing one or more quantitatively measured reasons for recommending the one or more of the sequences of the learning assets.

3. The system of claim 1, wherein the learning goal extraction and alignment module is further operable to generate additional learning goals at least based on available learning assets, the asset to competency mapping and the learning assets to concepts mapping.

4. The system of claim 1, wherein the sequence extraction and alignment module extracts the sequences of the learning assets based on a threshold number of support in the historical consumption data.

5. The system of claim 1, wherein the sequence extraction and alignment module extracts the sequences of the learning assets based on a threshold number of sequence length.

6. The system of claim 1, wherein the sequence extraction and alignment module further prunes the sequences of the learning assets based on one or more of adjacency and non-adjacency of duplicate assets.

7. The system of claim 1, wherein the concepts are annotated by uniform resource locators (URLs) corresponding to web pages of the knowledge-base.

8. The system of claim 1, wherein the sequence extraction and alignment module matches the learning assets to the learning goals using Naïve Bayes Model.

9. The system of claim 1, wherein the sequence extraction and alignment module matches the learning assets to the learning goals by relational matching that leverages knowledge-base relations and uses latent learning assets to concepts mapping.

10. The system of claim 1, wherein the learning goals further comprise job-roles.

11. A method of enhancing learning outcomes, comprising:
generating learning assets to concepts mapping, automatically by one or more processors, by extracting concepts from learning assets and characterizing the learning assets by mapping entities of a knowledge-base to the concepts;
receiving one or more of a learning goal;
mapping the learning goal to the learning assets at least based on the learning assets to concepts mapping and asset to competency mapping, the asset to competency mapping comprising mappings of assets to learning goals mapped based on the entities of the knowledge-base;
extracting sequences of the learning assets from historical consumption data; and
recommending one or more of the sequences of the learning assets corresponding to the learning goal.

12. The method of claim 11, wherein the learning goal is input as a job-role.

13. The method of claim 11, further comprising determining sequence associations to the learning goals, the sequence associations providing one or more quantitatively measured reasons for recommending the one or more of the sequences of the learning assets.

14. The method of claim 11, further comprising generating additional learning goals at least based on available learning assets, the asset to competency mapping and the learning assets to concepts mapping.

15. The method of claim 11, wherein the extracting sequences of the learning assets from historical consumption data comprises extracting the sequences of the learning assets based on one or more of a threshold number of support in the historical consumption data and a threshold sequence length.

16. The method of claim 11, wherein the extracting sequences of the learning assets from historical consumption data comprises pruning the extracted sequences of the learning assets based on one or more of adjacency and non-adjacency of duplicate assets.

17. The method of claim 11, wherein the sequence extraction and alignment module matches the learning assets to the learning goals using one or more of Naïve Bayes Model or
relational matching that leverages knowledge-base relations and uses latent learning assets to concepts mapping.

18. A computer readable storage medium storing a program of instructions executable by a machine to perform a method of A method of enhancing learning outcomes, comprising:
generating learning assets to concepts mapping, automatically by one or more processors, by extracting concepts from learning assets and characterizing the learning assets by mapping entities of a knowledge-base to the concepts;
receiving one or more of a learning goal;
mapping the learning goal to the learning assets at least based on the learning assets to concepts mapping and asset to competency mapping, the asset to competency mapping comprising mappings of assets to learning goals mapped based on the entities of the knowledge-base;
extracting sequences of the learning assets from historical consumption data; and
recommending one or more of the sequences of the learning assets corresponding to the learning goal.

19. The computer readable storage medium of claim 18, wherein the learning goal is input as a job-role.

20. The computer readable storage medium of claim 18, further comprising determining sequence associations to the learning goals, the sequence associations providing one or more quantitatively measured reasons for recommending the one or more of the sequences of the learning assets and generating additional learning goals at least based on available learning assets, the asset to competency mapping and the learning assets to concepts mapping.
